(19) United States
(12) Patent Application Publication
(10) Pub. No.: US 2012/0146885 A1
(43) Pub. Date: Jun. 14, 2012

(54) VOLUMETRIC THREE DIMENSIONAL PANEL AND DISPLAY APPARATUS USING THE SAME

(75) Inventor: Won-Chan JUNG, Daejeon-si (KR)

(73) Assignee: Electronics and Telecommunications Research Institute, Daejeon (KR)

(21) Appl. No.: 13/324,259

(22) Filed: Dec. 13, 2011

(30) Foreign Application Priority Data
Dec. 14, 2010 (KR) 10-2010-0127745

(51) Int. Cl. G09G 5/00; G02B 27/22

(52) U.S. Cl. 345/6; 359/462

(57) ABSTRACT

A volumetric three dimension panel, which is formed by stacking at least one transparent light emitting element up against each other in a three dimensional shape, and a display apparatus are provided. The volumetric three dimension panel is formed by stacking at least one transparent light emitting element up against each other in a three dimensional shape. The display apparatus includes a volumetric three dimension panel which is formed by stacking at least one transparent light emitting element up against each other in a three dimensional shape, a matching unit configured to match a value of coordinates of an object to the transparent light emitting element, and a display control unit configured to operate the transparent light emitting element based on a result of the matching and a pixel value which is matched to the value of coordinates of the object.

### CROSS-REFERENCE TO RELATED APPLICATION

This application claims the benefit under 35 U.S.C. §119(a) of Korean Patent Application No. 10-2010-0127745, filed on Dec. 14, 2010, the disclosure of which is incorporated by reference in its entirety for all purposes.

### BACKGROUND

1. Field

The following description relates to a display panel capable of displaying a three dimensional image by use of light emitting devices and a display apparatus having the same.

2. Description of the Related Art

A three-dimension image is achieved by a stereo vision through both eyes of a human. Binocular parallax caused by the distance of about 65 mm between both eyes serves as the most important factor to perceive 3-D image. In recent year, there is a need for a 3-D image display providing a 3-D image using such a binocular parallax in various fields including medical imaging, games, advertisement, education, military, etc. In addition, as a high resolution television is getting into popularity, it is expected that a 3-D television displaying will be widely used in the future. This trend leads to the development of various technologies of representing a three dimensional image.

In general, a 3-D display technology is classified into a glasses 3D, a glasses-less 3D and a fully 3-D.

According to the glasses-less 3D and the glasses 3D, two 2-D images are separately provided to both eyes of a user, respectively, thereby providing depth perception of 3D.

However, the glasses-3D requires a user to wear an additional accessory, such as a polarization glass, to view a 3-D image. The glasses-free 3D has one or more visual points that are fixed at one or more separated positions, producing a discontinuous image and thus causing inconvenience in which a user needs to stay still to view a 3-D image In addition, both of the glasses-3D and the glasses-free 3D only reproduce depth information of an object, and fail to represent images from various directions of a user.

The fully 3-D technology can implement a full 3-D image by matching a focus to a convergent angle of the eyes. The fully 3-D technology includes an integral photography and a holography. However, in the integral photography, the disparity and the viewing angle are limited by a lens. In addition, the holographic scheme requires a coherent light source, and has a difficult in recording and reproducing a large and distant object. Accordingly, there is a need for a technology capable of compensating for the above described drawbacks.

### SUMMARY

In one general aspect, there is provided a volumetric three dimension panel which is formed by stacking at least one transparent light emitting element up against each other in a three dimensional shape.

The transparent light emitting element may be connected to a transparent electrode to receive an electric power from the transparent electrode.

The volumetric three dimension panel may further include a transparent cover to cover the three dimensional shape.

The transparent light emitting element may be an organic light emitting device (OLED).

In another general aspect, there is provided a display apparatus including: a volumetric three dimension panel which is formed by stacking at least one transparent light emitting element up against each other in a three dimensional shape; a matching unit configured to match a value of coordinates of an object to the transparent light emitting element; and a display control unit configured to operate the transparent light emitting element based on a result of the matching and a pixel value which is matched to the value of coordinates of the object.

The transparent light emitting element may be connected to a transparent electrode to receive an electric power from the transparent electrode.

The display apparatus may further include a transparent cover to cover the three dimensional shape.

The transparent light emitting element may be an organic light emitting device (OLED).

Other features will become apparent to those skilled in the art from the following detailed description, which, taken in conjunction with the attached drawings, discloses exemplary embodiments of the invention.

### BRIEF DESCRIPTION OF THE DRAWINGS

FIG. 1 illustrates an example of a volumetric three dimensional panel.

FIG. 2 illustrates an example of a display apparatus having the volumetric three dimensional panel of FIG. 1.

Elements, features, and structures are denoted by the same reference numerals throughout the drawings and the detailed description, and the size and proportions of some elements may be exaggerated in the drawings for clarity and convenience.

### DETAILED DESCRIPTION

The following detailed description is provided to assist the reader in gaining a comprehensive understanding of the methods, apparatuses and/or systems described herein. Various changes, modifications, and equivalents of the systems, apparatuses and/or methods described herein will suggest themselves to those of ordinary skill in the art. Descriptions of well-known functions and structures are omitted to enhance clarity and conciseness.

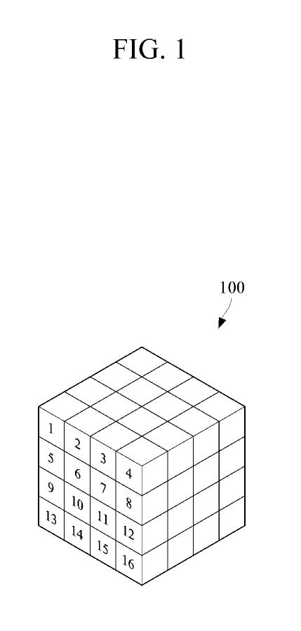

FIG. 1 illustrates an example of a volumetric three dimensional panel.

Referring to FIG. 1, a volumetric three dimensional panel 100 is formed by stacking at least one transparent light emitting element up again each other in a three dimensional shape. For example, the volumetric three dimensional panel 100 is provided in the shape of a cube. Hereinafter, the description will be made in relation to a volumetric three dimensional panel having a cubical shape, but the shape of the volumetric three dimensional panel 100 is not limited thereto. The volumetric three dimensional panel 100 may be provided in the shape of a cube formed by stacking 64 transparent light emitting elements. For example, transparent light emitting elements 1, 2, 3, 4, 5, 6, 7, 8, 9, 10, 11, 12, 13, 14, 15 and 16 may be stacked up against each other in a four-fold structure, thereby forming the volumetric three dimensional panel 100.

The transparent light emitting element is connected to a transparent electrode, and receives an electric power from the transparent electrode. For example, the transparent light emitting element may be provided between a transparent electrode and a cathode, or between transparent electrodes to receive an electric power through the transparent electrode.

For example, the light emitting element may be an organic light emitting device. For example, the organic light emitting device includes a transparent substrate, a transparent electrode formed on the transparent substrate, an organic light emitting layer formed on the transparent electrode and a cathode formed on the organic light emitting layer. The transparent substrate may be formed using polymer material such as plastics. The polymer material has an advantage of a low weight and superior flexibility. In recent years, a transparent Nano Fiber having a diameter of 100 nm or below is used as reinforcing material for a polymer substrate, thereby forming a polymer substrate having a superior flexibility, a transparency producing a transmittance of a parallel beam of about 85% or above and a low coefficient of thermal expansion. Meanwhile, the transparent electrode is formed using indium tin oxide (ITO). In addition, the organic light emitting layer is formed using mono-molecular material, such as tris-aluminum (Alq3) and Anthracene, and polymer, such as PPV (poly(p-phenylenevinylene)) and PT (polythiophene). In addition, in order to enhance the light emission efficiency, an electron transfer layer may be provided between a cathode and a organic light emitting layer and a hole transfer layer may be provided between a transparent electrode serving as an anode and a organic light emitting layer. The cathode is formed using metal having a relatively low work function. By forming the cathode using a transparent metal, a transparent organic light emitting device (OLED) is developed such that a user can observe images from a front side and a rear side of the transparent OLED at the same time.

A cover (not shown) is configured to cover the three dimensional shape, which is formed by stacking transparent light emitting elements up against each other. The cover may be formed using transparent material.

By operating the transparent light emitting elements each corresponding to a value of three dimensional coordinates of a three dimensional object, thereby forming a three dimensional image. In this case, the transparent light emitting element may emit a color of light that corresponds to a pixel value, which corresponds to a value of three dimensional coordinates. The pixel value may be a digital value representing hue, brightness and saturation.

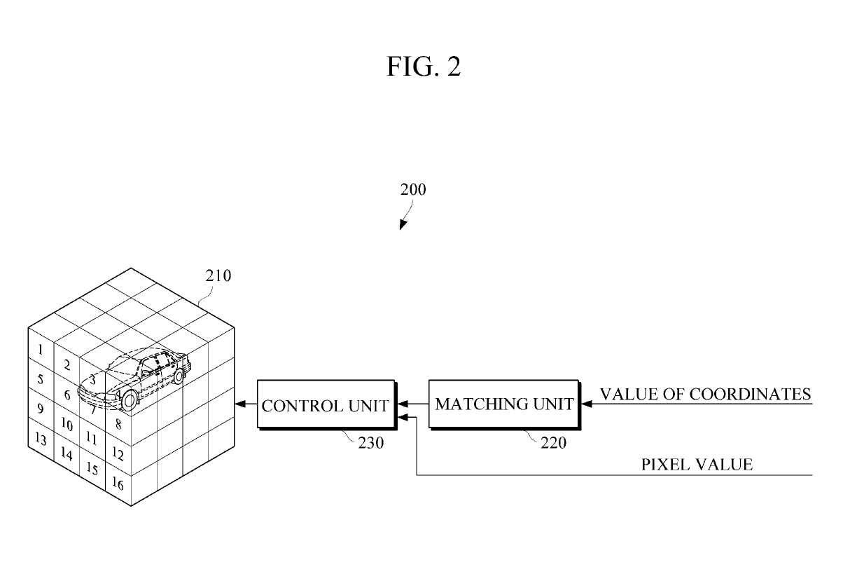

FIG. 2 illustrates an example of a display apparatus having the volumetric three dimensional panel of FIG. 1.

As shown in FIG. 2, a display apparatus 200 includes a volumetric three dimensional display panel 210, a matching unit 220 and a control unit 230.

The volumetric three dimensional display panel 210 is formed by stacking at least one transparent light emitting element up again each other in a three dimensional shape. For example, the volumetric three dimensional display panel 210 is provided in the shape of a cube. The transparent light emitting element is connected to a transparent electrode, and receives an electric power from the transparent electrode. For example, the transparent light emitting element may be provided between a transparent electrode and a cathode, or between transparent electrodes to receive an electric power through the transparent electrode.

A cover (not shown) is configured to cover the three dimensional shape that is formed by stacking transparent light emitting elements up against each other. The cover may be formed using transparent material.

The matching unit 220 matches a value of coordinates of an object to a transparent light emitting element of the volumetric three dimensional display panel 210. For example, the value of coordinates of the object may be a value of three dimensional coordinates or a value of two dimensional coordinates. The matching unit 220 matches the value of coordinates of the object to the transparent light emitting element. For example, if the value of coordinates of the object is (3, 1, 2), the matching unit 220 extracts a transparent light emitting element corresponding to the value (3, 1, 2) of coordinates of the object, and matches the value (3, 1, 2) to the extracted transparent light emitting element. In addition, if the value of coordinates of the object is (3, 1, 3), the matching unit 220 extracts a transparent light emitting element corresponding to the value (3, 1, 3) of coordinates of the object, and matches the value (3, 1, 3) to the extracted transparent light emitting element.

The control unit 230 operates the transparent light emitting element based on a result of the matching and a pixel value which is matched to the value of coordinates of the object. The control unit 230 may receive the pixel value, which is matched to the value of coordinates of the object, from an internal storage device or an external storage device. For example, the control unit 230 may select a transparent light emitting element corresponding to a value of coordinates of an object. The control unit 230 may extract a pixel value corresponding to the value of coordinates of the object. The control unit 230 may allow the selected transparent light emitting element to emit a color of light corresponding to the extracted pixel value. In this manner, the control unit 230 operates the respective transparent light emitting elements each corresponding to all values of coordinates of the object, thereby displaying an image of the object on the volumetric three dimensional display panel 210.

As described above, this example of the display apparatus has a volumetric three dimensional display panel formed by stacking a plurality of transparent light emitting elements up against each other in a three dimensional shape, and displays a two dimensional image or a three dimensional image by use of the volumetric three dimensional display panel, thereby displaying images having a perception of reality.

The disclosure can also be embodied as computer readable codes on a computer readable recording medium. The computer readable recording medium is any data storage device that can store data which can be thereafter read by a computer system.

Examples of the computer readable recording medium include read-only memory (ROM), random-access memory (RAM), CD-ROMs, magnetic tapes, floppy disks, optical data storage devices, and carrier waves such as data transmission through the Internet. The computer readable recording medium can also be distributed over network coupled computer systems so that the computer readable code is stored and executed in a distributed fashion.

Also, functional programs, codes, and code segments for accomplishing the present invention can be easily construed by programmers skilled in the art to which the present invention pertains. A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A volumetric three dimension panel which is formed by stacking at least one transparent light emitting element up against each other in a three dimensional shape.

2. The volumetric three dimension panel of claim 1, wherein the transparent light emitting element is connected to a transparent electrode to receive an electric power from the transparent electrode.

3. The volumetric three dimension panel of claim 1, further comprising a transparent cover to cover the three dimensional shape.

4. The volumetric three dimension panel of claim 1, wherein the transparent light emitting element is an organic light emitting device (OLED).

5. A display apparatus comprising:
a volumetric three dimension panel which is formed by stacking at least one transparent light emitting element up against each other in a three dimensional shape;
a matching unit configured to match a value of coordinates of an object to the transparent light emitting element; and
a display control unit configured to operate the transparent light emitting element based on a result of the matching and a pixel value which is matched to the value of coordinates of the object.

6. The display apparatus of claim 5, wherein the transparent light emitting element is connected to a transparent electrode to receive an electric power from the transparent electrode.

7. The display apparatus of claim 5, further comprising a transparent cover to cover the three dimensional shape.

8. The display apparatus of claim 5, wherein the transparent light emitting element is an organic light emitting device (OLED).
